(19) United States
(12) Patent Application Publication
(10) Pub. No.: US 2016/0340601 A1
(43) Pub. Date: Nov. 24, 2016

(54) LUBRICANT COMPOSITION CONTAINING ORGANOMODIFIED SILOXANES

(71) Applicants: Rene HÄNSEL, Dorsten (DE); Jennifer HOLTZINGER, Frankfurt am Main (DE); Ronny SONDJAJA, Darmstadt (DE); Michael FERENZ, Essen (DE); Peter SEIDENSTICKER, Haan (DE); Kirsten SCHÖNEMANN, Muelheim an der Ruhr (DE)

(72) Inventors: Rene HÄNSEL, Dorsten (DE); Jennifer HOLTZINGER, Frankfurt am Main (DE); Ronny SONDJAJA, Darmstadt (DE); Michael FERENZ, Essen (DE); Peter SEIDENSTICKER, Haan (DE); Kirsten SCHÖNEMANN, Muelheim an der Ruhr (DE)

(73) Assignee: Evonik Oil Additives GmbH, Darmstadt (DE)

(21) Appl. No.: 15/114,638

(22) PCT Filed: Jan. 16, 2015
(86) PCT No.: PCT/EP2015/050726

§ 371 Date: Jul. 27, 2016

(30) Foreign Application Priority Data
Feb. 4, 2014 (EP) 14153831.4

(51) Int. Cl. C10M 155/02; C08G 77/12; C08G 77/04; C08G 77/20; C10M 107/50; C08G 77/06

(52) U.S. Cl. CPC C10M 155/02; C10M 107/50; C08G 77/06; C08G 77/04; C08G 77/20; C08G 77/12; C10M 2229/046; C10N 2240/10; C10N 2230/02; C10M 2229/0445; C10M 2229/043; C10N 2230/06; C10M 2229/044; C10N 2240/04; C10N 2240/08; C10N 2240/30; C10N 2240/40

(57) ABSTRACT

The present invention relates to compositions comprising components AA which are obtainable by hydrosilylation reaction of organomodified siloxanes bearing Si—H— groups and/or terminally unsaturated organic groups, a preparation process thereof and use thereof as lubricants.

The present invention relates to compositions comprising components AA which are obtainable by hydrosilylation reaction of organomodified siloxanes bearing Si—H— groups and/or terminally unsatured organic groups, a process for preparing these compounds and their use as lubricants.

### BACKGROUND OF THE INVENTION

It is known that the viscosity of liquids, including lubricating oil, decreases as the operating temperature increases. The viscosity index (VI) is a quality indicator of lubricating oil, an arbitrary measure for the rate of change of kinematic viscosity with temperature. Many lubricant applications require the lubricant to perform across a wide range of conditions, for example in an engine, a transmission equipment or hydraulic equipment. Lubricants must reduce friction when an equipment is started from cold as well as when it is running at elevated temperatures. Oils with a high VI will not fluctuate much in viscosity over the range of operating temperature.

Adding polymers into lubricant oil has been known traditionally to improve the VI of the base oil. Polymers such as polyalkyl(meth)acrylates, olefin copolymers, polyisobutylenes, and styrene-butadiene copolymers have been widely known and commercially available as viscosity index improver (VII).

Another option to obtain high VI is to use synthetic base oil, which has an already high VI value. Polyalphaolefins (PAO), such as 1-decene oligomers, have found wide acceptability and commercial success as synthetic base lubricant. U.S. Pat. Nos. 4,827,064 and 4,827,073 (Mobil Oil) reported high VI base oil based on low-branch-ratio PAO. This high VI PAO can also be blended with mineral oil. Other class of synthetic base oil known and available in the market includes polyisobutenes, alkylated aromatics, polyolesters, polyglycols and polyalkylmethacrylate oligomers.

The use of silicone-based compound (polysiloxane) as synthetic lubricant has also been reported. Besides the well-known high VI, silicone-based compound is also known for other positive attributes, including excellent thermal stability as described in U.S. Pat. No. 2,950,250.

However, limited solubility in a variety of hydrocarbons reduces their potential lubricant applications.

In order to improve its compatibility with hydrocarbons, organo-functionalization to the silicone backbone of the polysiloxane compound is usually carried out.

U.S. Pat. No. 3,532,730 illustrates the use of triorganosilyl-endblocked copolymer fluids of C6-C10 alkylmethylsiloxane and arylmethylsiloxane as hydraulic fluids with excellent lubricity and low temperature performance.

Patent application US 2009/0227481 A1 describes a highly branched functionalized linear organomodified siloxane as lubricating oil with an improved traction coefficient. The siloxane backbone was functionalized with C1 to C45 alkyl or aryl. GB 1224885 discloses a lubricant composition comprising a mineral oil and as a Viscosity Index improver from 0.1 to 15% by weight thereof of an oil miscible linear diorganopolysiloxane, in which a major proportion of the organo groups are methyl groups and the remainder of the organo groups are substituted or unsubstituted alkyl, alkaryl or aralkyl groups having at least 6 and not more than 30 carbon atoms in amount sufficient to render it miscible with mineral oil.

EP 2535398 discloses lubricant compositions, comprising a base oil, a polyalphaolefin and silicone oil having a kinematic viscosity at 100 degrees C. in a range of 0.5 to 4 mm²/s, which are miscible with mineral oil and have an improved viscosity index without deteriorating the solubility. In particular, it is described the use of linear polydimethylsiloxane.

WO 2014/028632 A1 discloses a lubricant composition with a Viscosity Index of above 150 comprising a non-silicone base stock oil and a silicone oil, which can be a cyclic, linear or branched silicone polymer. No mention is made to crosslinked siloxanes.

However, even if the prior art lubricant compositions show good viscosity properties, there still exists the need to investigate further to improve the properties to the lubricants to meet the market needs.

### DESCRIPTION OF THE INVENTION

The objective of the present invention was to provide a lubricating base fluid having improved anti-friction properties, while maintaining good viscosity properties.

After an exhaustive investigation, the inventors of the present invention have surprisingly found that lubricant compositions comprising crosslinked organomodified siloxanes (OMS) show significant improvements in friction reduction, while maintaining good viscosity properties.

The crosslinked structure is obtained by reaction with divinyl siloxane in the presence of Pt catalyst as described in the experimental part. Surprisingly, it has been found that this crosslinked structure gives significant benefits in friction reduction, when being used as lubricating fluid.

With their widely adjustable surfactant behaviour, silicon-carbon linked, organomodified siloxanes, specifically polyethersiloxanes, represent an industrially very important substance class. The established way of producing these substances is the platinum-metal-catalysed addition reaction of siloxanes carrying SiH groups onto olefinically functionalized compounds (hydrosilylation). Olefinically functionalized compounds, which are often used, are, for example, allyl polyethers. The hydrosilylation can take place in the presence of a solvent or without a solvent (see EP 2 628 771 A1). Furthermore, the hydrosilylation can also be carried out in the presence of water, as described in the patent specification EP 1 754 740. Said patent discloses the preparation of aqueous solutions by the reaction of SiH-containing siloxanes or silanes with compounds which have at least one double bond in the presence of water as reaction medium. The SiH-containing siloxanes described therein contain no further functional groups, e.g. vinyl groups, meaning that the resulting polyethersiloxanes are uncrosslinked and have the performance known in the prior art. Moreover, this method is exclusively suitable for preparing water-soluble products and is thus limited.

The topology of organosiloxanes influences their properties considerably. This is evident from a very wide variety of applications, although it is often difficult or even impossible to predict to what extent the structural properties influence the performance of a siloxane polymer. As a rule, it requires an experiment in order to correlate structural and material properties with one another.

In particular, silicone materials and silicone resins can conveniently be identified according to a shorthand nomenclature system well known to those skilled in the art as the “MDTQ” nomenclature. Under this system, the silicone is described according to the presence of various siloxane monomer units which make up the silicone. Briefly, the symbol M denotes the mono-functional units, like for example (CH₃)₃SiO)_{0.5}; D denotes the difunctional units, like for example (CH₃)₂SiO; T denotes the trifunctional units, like for example (CH₃)SiO_{1.5}; and Q denotes the quadra- or tetra-functional units, like for example SiO₂.

According to the present invention, it is claimed a lubricating base fluid, comprising a cross-linked component AA obtainable by hydrosilylation of at least one organomodified siloxane A of general formula (I)

MₐM^{H}_{b}M^{V}_{c}d_{d}D^{H}ₑD^{V}_{f}T_{g}T^{H}ₕQₗ (I),
wherein
M is a building block [R¹₃SiO_{1/2}],
M^{H} is a building block [R¹₂R²SiO_{1/2}],
M^{V} is a building block [R¹₂R³SiO_{1/2}],
D is a building block [R¹₂SiO_{2/2}],
D^{H} is a building block [R¹R²SiO_{2/2}],
D^{V} is a building block [R¹₂R³SiO_{2/2}],
T is a building block [R¹SiO_{3/2}],
T^{H} is a building block [R²SiO_{3/2}],
Q is a building block [SiO_{4/2}],
R¹ is independently of one another, identical or different and selected form the group consisting of alkyl radicals having from 1 to 18 carbon atoms and phenyl group, preferably methyl or phenyl,
R² is hydrogen,
R³ is independently of one another and identical or different organic radicals with a terminal C—C-double bond or a terminal or internal C—C-triple bond, preferably organic radicals with a terminal double bond, in particular vinyl (i.e. —CH═CH₂) or allyl (i.e. —CH₂CH═CH₂),
a is an even or uneven, positive number 0 to 80, preferably 0 to 50, more preferably 0 to 25, especially preferably 0 to 5,
b is an even or uneven, positive number 0 to 80, preferably 0 to 30, more preferably 0 to 15, especially preferably 0 to 5,
c is an even or uneven, positive number 0 to 80, preferably 0 to 30, more preferably 0 to 15, especially preferably 0 to 5,
d is an even or uneven, positive number 10 to 1200, preferably 20 to 900, more preferably 25 to 500, especially preferably 30 to 200,
e is a number 0 to 100, preferably 0 to 80, more preferably 0 to 60, especially preferably 0 to 25,
f is a number 0 to 100, preferably 0 to 80, more preferably 0 to 60, especially preferably 0 to 25,
g is an even or uneven, positive number 0 to 30, preferably 0 to 20, more preferably 1 to 15, especially preferably 1 to 5,
h is an even or uneven, positive number 0 to 20, preferably 0 to 10, more preferably 0,
l is an even or uneven, positive number 0 to 20, preferably 0 to 15, more preferably 0,
with the proviso that the following conditions are satisfied:
a+b+c is not more than 8, preferably a number less than or equal to 4, more preferably a number less than or equal to 3, and even more preferably equal to 2,
g+h+l is not more than 20, preferably a number less than 15, more preferably a number less than 5, and even more preferably equal to 0,
b+e+h is not more than 30, preferably a number less than 20, more preferably a number less than 15, even more preferably less than 10, and most preferably less than 5,
c +f is not more than 20, preferably a number less than 15, more preferably a number less than 20, and even more preferably equal to 2,
one or more unsaturated organic compounds of general formula (II)

CH₂═CHX (II)
wherein
X is hydrogen or an alkyl, aryl, alkaryl group having 1 to 30 carbon atoms, more preferably 6 to 14 carbon atoms, which optionally are substituted by one or more hydroxyl or methoxy radical,
   and at least one organomodified siloxane B of general formula (III)

M_{a′}M^{H}_{b′}D_{d′}D^{H}_{e′}T_{g′}T^{H}_{h′}Q_{l′} (III),
wherein
a′ is an even or uneven, positive number 0 to 80, preferably 0 to 50, more preferably 0 to 25, especially preferably 0 to 5,
b′ is an even or uneven, positive number 0 to 80, preferably 0 to 30, more preferably 0 to 15, especially preferably 0 to 5
d′ is an even or uneven, positive number 10 to 1200, preferably 20 to 900, more preferably 25 to 500, especially preferably 30 to 200,
e′ is a number 0 to 100, preferably 0 to 80, more preferably 0 to 60, especially preferably 0 to 25,
g′ is an even or uneven, positive number 0 to 30, preferably 0 to 20, more preferably 1 to 15, especially preferably 1 to 5,
h′ is an even or uneven, positive number 0 to 20, preferably 0 to 10, more preferably 0,
l′ is an even or uneven, positive number 0 to 20, preferably 0 to 15, more preferably 0,
with the proviso that the following conditions are satisfied:
a′+b′ is not more than 8, preferably a number less than or equal to 4, more preferably a number less than or equal to 3, and even more preferably equal to 2,
g′+h′+l′ is not more than 20, preferably a number less than 15, more preferably a number less than 5, and even more preferably equal to 0,
b′+e′+h′ is not more than 30, preferably a number less than 20, more preferably a number less than 15, even more preferably less than 10, and most preferably less than 5.

The various fragments in formula (I) above can be in random distribution. Random distributions can have a blockwise structure with any desired number of blocks and any desired sequence or they can be subject to a randomized distribution. They may also have an alternating structure or else form a gradient via the chain, in particular they can also form all mixed forms in which optionally groups of different distributions can follow one another. Formula (I) describes polymers which have a molecular weight distribution. Consequently, the indices represent the numerical average over all monomer units.

The index numbers a, b, c, d, e, f, g, h and l used in formula (I), as well as the index numbers a′, b′, d′, e′, g′, h′ and l′ used in formula (III), are average values. However, the polymer AA has a molecular weight distribution.

The aforementioned compounds according to formula (II) are preferably olefins. Preferred olefins are olefins with terminal double bonds, e.g. alpha-olefins. Particularly preferred olefins are ethene, propene, 1-butene, 1-hexene, 1-octene, 1-dodecene, 1-hexadecene, preferably 1-dodecene.

In a further embodiment, the at least one crosslinked component AA is obtainable by hydrosilylating a composition of organomodified siloxane A of general formula (I), organomodified siloxane B of general formula (III) and unsaturated organic compounds of general formula (II), the composition comprising
(a) 0.2% to 10% by weight, preferably 0.5% to 5% by weight of compound A of general formula (I) based on the total weight of compounds A of general formula (I), B of general formula (III) and unsaturated organic compounds of general formula (II),
b) 30% to 85% by weight, preferably 40% to 70% by weight, of compound B of general formula (III), based on the total weight of compounds A of general formula (I), B of general formula (III) and unsaturated organic compounds of general formula (II),
(c) 5% to 69.8% by weight, preferably 30% to 55% by weight, of compounds of general formula (II), based on the total weight of compounds A of general formula (I), B of general formula (III) and unsaturated organic compounds of general formula (II),
(d) 1 to 50 ppm by weight, preferably 2 to 10 ppm by weight of a catalyst, based on the total weight of the composition and
(e) optionally further constituents.

The present invention describes the rheology and tribology advantages of using a crosslinked organomodified siloxane in the lubricant application. Specifically, the data suggest that the introduction of the cross-linked structure gives friction reduction, while maintaining good viscosity index (VI) value of the lubricant.

As a second embodiment, the present invention is directed to a method of reducing the friction and/or traction coefficient by using the cross-linked component AA as defined in claims 1 to 3 as a lubricant.

A third embodiment of the present invention is directed to a lubricating composition, comprising

(1) at least one cross-linked component AA obtainable by cross-linking a composition of organomodified siloxane A of general formula (I) with at least one organomodified siloxane B of general formula (III) and unsaturated organic compounds of general formula (II) as mentioned above;

(2) at least one base oil derived from mineral oil, synthetic oil and/or oil of natural origins.

In the compositions according to the invention, the at least one cross-linked component AA comprises of several molecules of different molecular masses caused by the different cross linking degree. The component AA therefore consists of at least 90% by weight of molecules with weight-average molar mass (M_{w}) of 2,500,000 g/mol.

The compositions according to the invention contain 50 to 100%, preferably 70 to 100%, more preferably 85 to 100% by weight, of the at least one cross-linked component AA, based on the total weight of the lubricating composition.

In the compositions according to the invention, the at least one base oil is present in an amount of 0 to 50%, preferably 0 to 30%, more preferably 0 to 15% by weight, based on the total weight of the lubricating composition.

The lubricant composition according to this invention can be useful for various applications including industrial gear oil, lubricant for wind turbine, compressor oil, hydraulic fluid, paper machine lubricant, engine or motor oil, transmission and/or drive-trains fluid, machine tools lubricant, metalworking fluids, and transformer oils to name a few. The base fluid of the lubricants according to this invention may also be blended with other base oils. These other base oils are selected from bases derived from mineral oil, synthetic oil and/or oil of natural origins.

Mineral oils are known per se and commercially available. They are generally obtained from mineral oil or crude oil by distillation and/or refining and optionally further purification and finishing processes, the term “mineral oil” including in particular the higher-boiling fractions of crude or mineral oil. In general, the boiling point of mineral oil is higher than 200° C., preferably higher than 300° C., at 5000 Pa. The production by low-temperature carbonization of shale oil, coking of bituminous coal, distillation of brown coal with exclusion of air, and also hydrogenation of bituminous or brown coal is likewise possible. Accordingly, mineral oils have, depending on their origin, different proportions of aromatic, cyclic, branched and linear hydrocarbons.

In general, a distinction is drawn between paraffin-base, naphthenic and aromatic fractions in crude oils or mineral oils, in which the term “paraffin-base fraction” represents longer-chain or highly branched isoalkanes, and “naphthenic fraction” represents cycloalkanes. In addition, mineral oils, depending on their origin and finishing, have different fractions of n-alkanes, isoalkanes having a low degree of branching, known as mono-methyl-branched paraffins, and compounds having heteroatoms, in particular O, N and/or S, to which a degree of polar properties are attributed. However, the assignment is difficult, since individual alkane molecules may have both long-chain branched groups and cycloalkane radicals, and aromatic parts. For the purposes of the present invention, the assignment can be effected to DIN 51 378, for example. Polar fractions can also be determined to ASTM D 2007.

The proportion of n-alkanes in preferred mineral oils is less than 3% by weight, the fraction of O-, N- and/or S-containing compounds less than 6% by weight. The fraction of the aromatics and of the mono-methyl-branched paraffins is generally in each case in the range from 0 to 40% by weight. In one interesting aspect, mineral oil comprises mainly naphthenic and paraffin-base alkanes which have generally more than 13, preferably more than 18 and most preferably more than 20 carbon atoms. The fraction of these compounds is generally 60% by weight, preferably 80% by weight, without any intention that this should impose a restriction. A preferred mineral oil contains 0.5 to 30% by weight of aromatic fractions, 15 to 40% by weight of naphthenic fractions, 35 to 80% by weight of paraffin-base fractions, up to 3% by weight of n-alkanes and 0.05 to 5% by weight of polar compounds, based in each case on the total weight of the mineral oil.

An analysis of particularly preferred mineral oils, which was effected by means of conventional processes such as urea separation and liquid chromatography on silica gel, shows, for example, the following constituents, the percentages relating to the total weight of the particular mineral oil used:

n-alkanes having approx. 18 to 31 carbon atoms:

0.7-1.0%,

slightly branched alkanes having 18 to 31 carbon atoms:

1.0-8.0%,

aromatics having 14 to 32 carbon atoms:

0.4-10.7%,

iso- and cycloalkanes having 20 to 32 carbon atoms:

60.7-82.4%,

polar compounds:

0.1-0.8%,

loss:

6.9-19.4%.

An improved class of mineral oils (reduced sulfur content, reduced nitrogen content, higher viscosity index, lower pour point) results from hydrogen treatment of the mineral oils (hydroisomerization, hydrocracking, hydrotreatment, hydrofinishing). In the presence of hydrogen, this essentially reduces aromatic components and builds up naphthenic components.

Valuable information with regard to the analysis of mineral oils and a list of mineral oils which have a different composition can be found, for example, in Ullmann's Encyclopedia of Industrial Chemistry, 5th Edition on CD-ROM, 1997, under “lubricants and related products”.

Synthetic oils include organic esters, for example diesters and polyesters, polyalkylene glycols, polyethers, synthetic hydrocarbons, especially polyolefins, among which preference is given to polyalphaolefins (PA0s), silicone oils and perfluoroalkyl ethers. In addition, it is possible to use synthetic base oils originating from gas to liquid (GTL), coal to liquid (CTL) or biomass to liquid (BTL) processes. They are usually somewhat more expensive than the mineral oils, but have advantages with regard to their performance.

GTL oils may be oils from Fischer-Tropsch-synthesised hydrocarbons made from synthesis gas containing hydrogen and carbon monoxide using a Fischer-Tropsch catalyst. These hydrocarbons typically require further processing in order to be useful as base oil. For example, they may, by methods known in the art be hydroisomerized, dewaxed, or hydroisomerized and dewaxed.

Natural oils are animal or vegetable oils.

Examples of vegetable oils which can be used in accordance with the invention are palm oil, rapeseed oil, coriander oil, soya oil, cottonseed oil, sunflower oil, castor oil, olive oil, groundnut oil, corn oil, almond oil, palm kernel oil, coconut oil, mustard seed oil, jojoba oil, jatropa oil, olive oil etc. Examples of animal fats which can be used in accordance with the invention are oils which are derived from animal tallow, especially beef tallow, bone oil, fish oils, lard, chicken oil, whale sperm, etc. and used cooking oils. Further examples include oils which derive from cereal, wheat, jute, sesame, rice husks, jatropha, arachis oil and linseed oil.

Base oils for lubricant oil formulations are divided into groups according to API (American Petroleum Institute). Mineral oils are divided into group I (non-hydrogen-treated; sulfur content>0.03 wt. % and/or 90 wt. % saturates, viscosity index 80-120) and, depending on the degree of saturation, sulfur content and viscosity index, into groups II (hydrogen-treated; sulfur content<0.03 wt. %, and >90 wt. % saturates, viscosity index 80-120) and III (hydrogen-treated; sulfur content<0.03 wt. %, and >90 wt. % saturates, viscosity index >120). PAOs correspond to group IV. All other base oils are encompassed in group V.

The lubricant oils (base oils) used may especially be oils having a viscosity in the range from 3 mm²/s to 100 mm²/s, more preferably 13 mm²/s to 65 mm²/s, measured at 40° C. to ASTM 445. The use of these base oils allows surprising advantages to be achieved with regard to fuel economy benefits.

These lubricant oils may also be used as mixtures and are in many cases commercially available.

The compositions according to the invention can optionally comprise further additives. Preferred additives include antiwear, EP additives, corrosion inhibitors and/or rust inhibiting additives, metal deactivators, detergents, dispersants, friction modifiers, pour point depressants, antioxidant, anti-ageing compositions, odorants, dyes, antifoam, demulsifiers, viscosity index improvers, and mixtures thereof.

A further embodiment of the invention is directed to process of preparation of components AA according to the invention, characterized in that at least one compound A of the general formula (I) is reacted with at least one compound B of the general formula (III) and with other compounds of the general formula (II) under hydrosilylation conditions and in the presence of a hydrosilylation catalyst.

In general, the reactants can be added to the reaction vessel in any desired order.

The process according to the invention can be carried out in the presence of one or more solvents. The process according to the invention can be carried out with the addition of one or more emulsifiers.

Suitable solvents are, for example, those which do not inhibit or disturb the hydrosilylation reaction. Suitable solvents are, for example, aromatic and aliphatic hydrocarbons, linear or cyclic ethers, alcohols, esters or mixtures of different solvents.

In a further embodiment, it may be advantageous to prepare the components AA according to the invention without emulsifiers.

The individual reactants can likewise be added in portions at different times of the emulsification. This procedure is adequately known to the person skilled in the art. The theoretical principles for preparing emulsions are described inter alia in Tharwat F. Tadros—“Emulsion Science and Technology” (Wiley-VCH Verlag GmbH & Co. KGaA; edition: 1st Edition; 18 March 2009; ISBN-10: 3527325255). Emulsification methods are also listed in U.S. Pat. No. 4,476,282 and US 2001/0031792, which are hereby incorporated in their entirety into the scope of protection of the present invention. The cited references also contain details relating to mixing the reactants; this can take place in different ways, it being possible to use a wide variety of stirring units.

The mixing operation can be carried out as a batch process (one-pot process), semi-continuous process or continuous process.

When carrying out the process according to the invention, the reaction components are preferably supplied to the reaction vessel, with the proviso that, prior to starting to add the catalyst, at least one aliquot of the compound of general formula (I) or at least one aliquot of a mixture comprising the compound of general formula (III) and an unsaturated compound of general formula (II) is present in the reaction mixture in the reaction vessel.

The dosage order can be varied within a wide scope. In some cases, it is advantageous to introduce reactants simultaneously. Moreover, the individual reactants can be premixed and fedto the reactor. It is also possible to add certain reactants in portions at different stages of the reaction. The manner in which the reaction is carried out can significantly influence the composition of the product.

Thus, in a preferred embodiment of the invention, the compounds of general formula (I) and (III) are introduced into the reaction vessel, brought to the reaction temperature and then admixed with a hydrosilylation catalyst. The compounds of general formula (II) are then added.

In another embodiment, it may be advantageous to introduce the compounds of general formula (II) and then to add in the compounds of the formula (I) and (III). Suitable and preferred conditions for the hydrosilylation reaction are described e.g. in EP 1 520 870 (application examples 1, 4-7); these are hereby incorporated by reference and form part of the disclosure of the present invention.

The process according to the invention is preferably carried out in such way that a high conversion with regard to the Si-H functions is reached. Preferably, a high conversion means a conversion greater than 99%, preferably greater than 99.9%. Catalysts which can be used for the hydrosilylation are metal catalysts, preferably precious metal catalysts of the platinum group, preferably platinum-, rhodium- or ruthenium-containing catalysts, in particular complexes which are known to the person skilled in the art as hydrosilylating-active catalysts, e.g. platinum compounds such as, for example, hexachloroplatinic acid, (NH₃)₂PtCl₂, cis-platinum, bis(cyclooctene)platinum dichloride, carbo platinum, platinum(0)-(divinyltetramethyldisiloxane) complexes, so-called Karstedt catalysts, or else platinum(0) complexes complexed with different olefins. Of suitability in principle are furthermore rhodium and ruthenium compounds, such as, for example, tris(triphenylphosphine)rhodium(I) chloride or tris(triphenylphosphine)rhuthenium(II) dichloride. Catalysts preferred in the course of the process according to the invention are platinum(0) complexes. Particular preference is given to Karstedt catalysts or a Pt(0) catalystas prepared according to EP 1 520 870.

The person skilled in the art is aware that the catalyst has to be selected such that it is not inhibited or inactivated by the individual components of the reaction used, preference being given to catalyst/reactant mixtures which do not influence the properties and also the reactivity of the catalyst.

The catalysts are preferably used in an amount of from 0.1 to 100 ppm, more preferably 1 to 50 ppm, particularly preferably 1 to 30 ppm and especially preferably 2 to 10 ppm, based on the total weight of the total mixture of the hydrosilylation reaction.

### BRIEF DESCRIPTION OF THE DRAWINGS

The drawing described herein is for illustration purposes only and is not intended to limit the scope of the present disclosure in any way.

FIG. 1 is a graphical representation of the Stribeck curves at 100 degree C., 30N load and 50% SRR (Sliding Roll Ratio) for each of the prepared organomodified siloxanes according to Example 1 and comparative examples 1 and 2.

### EXPERIMENTAL PART

The following specific embodiments are given to illustrate the preparation and properties of the crosslinked organomodified siloxanes according to the present invention and should not be construed to limit the scope of the disclosure.

Preparation examples:

Siloxane A: M^{V}D_{35.5}D^{H}_{12.5}M^{V}

Siloxane B: MD_{35.5}D^{H}_{12.5}M

Siloxane C: M^{H}D₇₈M^{H} (Comparative example)

R¹: Methyl

R²: Hydrogen

R³: Vinyl

### Example 1

### Preparation of a Crosslinked Organomodified Polysiloxane According to the Invention

325 g siloxane B [R¹₃SiO_{1/2}][R¹₂SiO_{2/2}]_{35.5}[R¹HSiO_{2/2}]_{12.5}[R¹₃SiO_{1/2}] were placed together with 12 g siloxane A [R¹₂R³SiO_{1/2}][R¹₂SiO_{2/2}]_{35.5}[R¹HSiO_{2/2}]_{12.5}[R¹₂R³SiO_{1/2}], 263 g 1-dodecene (CAS: 112-41-4) and 600 g toluene in a 2-L-three-necked flask with stirrer and Dimroth condenser. The mixture was heated to 100° C. and 8 ppm of Pt in the form of the Karstedt-catalyst were added. An exothermic reaction was observed. The mixture was stirred for additional 2 h at 100° C. Afterwards the volatile components were removed under reduced pressure (<10 mbar) at 100° C. A colourless liquid was obtained without any formation of gel. The viscosity of the end product is indicated in Table 1 below. Said end product contains 2% by weight of siloxane A (crosslinker), based on the total weight of reactants.

### Comparative Example 1

### Preparation of the Same Organomodified Polysiloxane as in Example 1, but with a Linear Structure (No Siloxane A as Crosslinker)

336 g siloxane B [R¹₃SiO_{1/2}][R¹₂SiO_{2/2}]_{35.5}[R¹HSiO_{2/2}]_{12.5}[R¹₃SiO_{1/2}] were placed together with 264 g 1-dodecene (CAS: 112-41-4) and 600 g toluene in a 2-L-three-necked flask with stirrer and Dimroth condenser. The mixture was heated to 100° C. and 8 ppm Pt in the form of the Karstedt-catalyst were added. An exothermic reaction was observed. The mixture was stirred for additional 2 h at 100 ° C. Afterwards the volatile components were removed under reduced pressure (<10 mbar) at 100° C. A colourless liquid was obtained. The viscosity of the end product is indicated in Table 1 below.

### Comparative Example 2

### Preparation of a Linear Polysiloxane

Comparative Example 2 was prepared according to US 2009/0027481 A1. 230 g of siloxane C [R¹₂R²SiO_{1/2}][R¹₂SiO_{2/2}]₇₈[R¹₂R²SiO_{1/2}] were placed together with 20 g Methyl 10-undecenoate (CAS: 111-81-9) in a 500-mL-three-necked flask with stirrer and Dimroth condenser. The mixture was heated to 90° C. and 8 ppm Pt in the form of the Karstedt-catalyst were added. An exothermic reaction was observed. The mixture was stirred for additional 2 h at 90° C. A colourless liquid was obtained. The viscosity of the end product is indicated in Table 1 below.

### Properties of the Fluids

The properties, in particular the viscosity values of the different organomodified siloxanes prepared according to inventive Example 1 and the current state-of-the-art fluids (Comparative examples 1 and 2) are summarized in Table 1. Kinematic viscosity at 40° C. and 100° C. were evaluated as described in ASTM D445. The viscosity index (VI) value is calculated from the kinematic viscosity at 40° C. and 100° C. as described in ASTM Method D2270

In addition to the kinematic viscosities, the following analysis measurements were carried out to further evaluate the properties of the fluids:
pour point value was measured by ISL Tilt Method based on ASTM D5950, the tribology behaviors of the claimed fluid and state-of-the-art fluids were evaluated by mini traction machine (MTM) equipment. The configuration of the MTM test specimens includes 19.05 mm (¾ inch) steel ball and a 46 mm diameter steel disc. The ball is loaded against the face of the disc and the ball and disc are driven independently to create a mixed rolling/sliding contact. The frictional force between the ball and disc is measured by a force transducer.

TABLE 1

| | | Comparative | Comparative |
|---|---|---|---|
| | Example 1 | Example 1 | Example 2 |
| | (crosslinked | (linear | (linear |
| Properties | structure) | structure) | structure) |
| Siloxane A (Crosslinker) | 2% by weight | 0% | 0% |
| Kinematic viscosity at | 105.0 | 101.77 | 83.16 |
| 40° C. (mm²/s) | | | |
| Kinematic viscosity at | 33.49 | 33.09 | 33.27 |
| 100° C. (mm²/s) | | | |
| Viscosity Index | 348 | 353 | 410 |
| Pour point (° C.) | −33 | | |

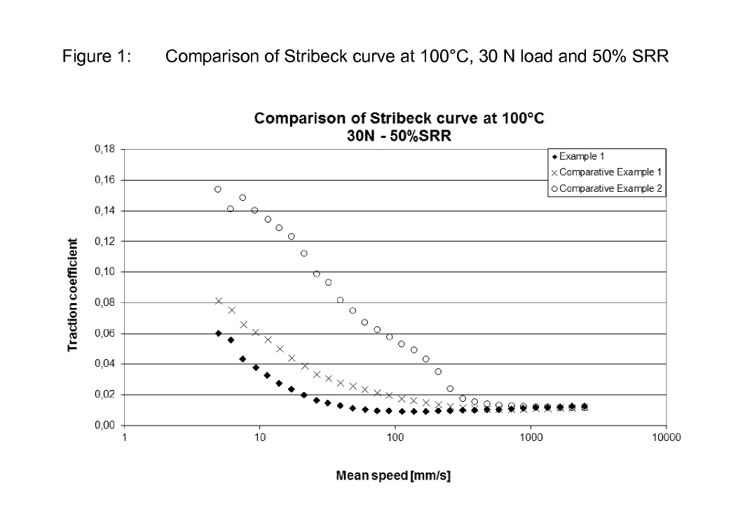

The tribological behaviour of the claimed fluid can be observed via FIG. 1, illustrating more significant reduction of the traction coefficient from the sample containing crosslinked structure, versus the comparative state-of-the-art linear structure.

FIG. 1 shows the comparison of a Stribeck curve at 100° C., 30 N load and 50% SRR (slide-roll-ratio) between Example 1 (♦) and the two Comparative Examples 1 (x) and 2 (∘). The results show clearly that the new claimed structure could significantly reduce the traction coefficient in comparison to the prior art structure. And as the MTM tests were done at 100° C., the temperature condition which all three samples have the similar kinematic viscosity (as seen in Table 1), the reduction of traction coefficient illustrated in FIG. 1 can be deduced as purely originated from the new invented structure.

Based on the comparative data stated above, it can be clearly derived that the crosslinking structure would give a significant boost in improving the reduction of friction at various temperatures.

With the remarkable low friction properties of the present inventive fluid, together with good viscosity properties (see FIG. 1 and Table 1, respectively), the claimed component is preferable to be used as lubricant or blend component in lubricant in comparison with the standard known fluids.

1-8. (canceled)

9. A method of reducing the friction and/or traction coefficient comprising
contacting an object with a lubricating base fluid, wherein said lubricating base fluid comprises a cross-linked component AA obtainable by hydrosilylation of at least one organomodified siloxane A of general formula (I), one or more unsaturated organic compounds of general formula (II), and at least one organomodified siloxane B of general formula (III);
wherein the at least one organomodified siloxane A of general fortnula (I) comprises:
MₐM^{H}_{b}M^{V}_{c}D_{d}D^{H}ₑD^{V}_{f}T_{g}T^{H}ₕQₗ (I),
wherein
M is a building block [R¹₃SiO_{1/2}],
M^{H} is a building block [R¹₂R²SiO_{1/2}],
M^{V} is a building block [R¹₂R²SiO_{1/2}],
D is a building block [R¹₂SiO_{2/2}],
D^{H} is a building block [R¹R²SiO_{2/2}],
D^{V} is a building block [R¹₂R³SiO_{2,2}],
T is a building block [R¹SiO_{3/2}],
T^{H} is a building block [R²SiO_{3/2}],
Q is a building block [SiO_{4/2}],
R¹ is independently of one another, identical or different and is at least one selected from the group consisting of alkyl radicals having from 1 to 18 carbon atoms and phenyl group,
R² is hydrogen,
R³ is independently of one another and identical or different organic radicals with a terminal C—C-double bond or a terminal or internal C—C-triple bond,
a is an even or uneven, positive number 0 to 80,
b is an even or uneven, positive number 0 to 80,
c is an even or uneven, positive number 0 to 80,
d is an even or uneven, positive number 10 to 1200,
e is a number 0 to 100,
f is a number 0 to 100,
g is an even or uneven, positive number 0 to 30,
h is an even or uneven, positive number 0 to 20,
l is an even or uneven, positive number 0 to 20,
with the proviso that the following conditions are satisfied:
a+b+c is not more than 8,
a+h+1 is not more than 20,
b+e+h is not more than 30,
c+f is not more than 20;
wherein the one or more unsaturated organic compounds of general formula (II) comprise:
CH₂═CHX (II)
wherein
X is hydrogen or an alkyl, aryl, alkaryl group having 1 to 30 carbon atoms, which optionally are substituted by one or more hydroxyl or methoxy radical; and
wherein the at least one organomodified siloxane B of general formula (III) comprises:
M_{a′}M^{H}_{b′}D_{d′}D^{H}_{e′}T_{g′}T^{H}_{h′}Q_{l′} (III),
wherein
a′ is an even or uneven, positive number 0 to 80,
b′ is an even or uneven, positive number 0 to 80,
d′ is an even or uneven, positive number 10 to 1200,
e′ is a number 0 to 100,
g′ is an even or uneven, positive number 0 to 30,
h′ is an even or uneven, positive number 0 to 20,
l′ is an even or uneven, positive number 0 to 20,
with the proviso that the following conditions are satisfied:
a′+b′ is not more than 8,
g′+h′+l′ is not more than 20,
b′ +e′ h′ is not more than 30.

10. The method according to claim 9, wherein the at least one cross-linked component AA is obtainable by hydrosilylating a composition of organomodified siloxane A of general formula (I), organomodified siloxane B of general formula (III) and unsaturated organic compounds of general formula (II), the composition comprising:
(a) 0.2% to 10% by weight of compound A of general formula (I), based on the total weight of compounds A of general formula (I), B of general formula (III) and unsaturated organic compounds of general formula (II),
b) 30% to 85% by weight of compound B of general formula based on the total weight of compounds A of general formula (I), B of general formula (III) and unsaturated organic compounds of general formula (II),
(c) 5% to 69.8% by weight of compounds of general formula (II), based on the total weight of compounds A of general formula (I), B of general formula (III) and unsaturated organic compounds of general formula (II),
(d) 1 to 50 ppm by weight of a catalyst, based on the total weight of the composition and
(e) optionally, further constituents.

11. A lubricating composition, comprising:
(1) 50 to 100% by weight of at least one cross-linked component AA obtainable by hydrosilylating a composition of at least one organomodified siloxane A of formula (I), at least one organomodified siloxane B of formula (III), and one or more unsaturated organic compounds of general formula (II); and
(2) 0 to less than 50% by weight of at least one base oil derived from mineral oil, synthetic oil and/or oil of natural origin;
wherein the at least one organomodified siloxane A of general formula (I) comprises:
MₐM^{H}_{b}M^{V}_{c}D_{d}D^{H}ₑD^{V}_{f}T_{g}T^{H}ₕQₗ (I)
wherein
M is a building block [R¹₃SiO_{1/2}],
M^{H} is a building block [R¹₂R²SiO_{1/2}],
M^{V} is a building block [R¹₂R³SiO_{1/2}],
D is a building block [R¹₂SiO_{2/2}],
D^{H} is a building block [R¹R²SiO_{2/2}],
D^{V} is a building block [R¹₂R³SiO_{2,2}],
T is a building block [R¹SiO_{3,2}],
T^{H} is a building block [R²SiO_{3/2}],
Q is a building block [SiO_{4/2}],
R¹ is independently of one another, identical or different and is at least one selected from the group consisting of alkyl radicals having from 1 to 18 carbon atoms and phenyl group,
R² is hydrogen,
R³ is independently of one another and identical or different organic radicals with a terminal C—C-double bond or a terminal or internal C—C-triple bond,
a is an even or uneven, positive number 0 to 80,
b is an even or uneven, positive number 0 to 80,
c is an even or uneven, positive number 0 to 80,
d is an even or uneven, positive number 10 to 1200,
e is a number 0 to 100,
f is a number 0 to 100,
g is an even or uneven, positive number 0 to 30,
h is an even or uneven, positive number 0 to 20,
l is an even or uneven, positive number 0 to 20,
with the proviso that the following conditions are satisfied:
a+b+c is not more than 8,
g+h+l is not more than 20,
b+e+h is not more than 30,
c+f is not more than 20;
wherein the one or more unsaturated organic compounds of general formula (II) comprise(s):
CH₂═CHX (II),
wherein
X is hydrogen or an alkyl, aryl, alkaryl group having 1 to 30 carbon atoms, which optionally are substituted by one or more hydroxyl or methoxy radical; and
wherein the at least one organomodified siloxane B of general formula (III) comprises(s):
M_{a′}M^{H}_{b′}D_{d′}D^{H}_{e′}T_{g′}T^{H}_{h′}Q_{l′} (III),
wherein
a′ is an even or uneven, positive number 0 to 80,
b′ is an even or uneven, positive number 0 to 80,
d′ is an even or uneven, positive number 10 to 1200,
e′ is a number 0 to 100,
g′ is an even or uneven, positive number 0 to 30,
h′ is an even or uneven, positive number 0 to 20,
l′ is an even or uneven, positive number 0 to 20,
with the proviso that the following conditions are satisfied:
a′+b′ is not more than 8,
g′+h′+l′ is not more than 20,
b′+e′+h′ is not more than 30.

12. The lubricating composition according to claim 11, wherein the at least one cross-linked component AA is present in an amount of 70 to 100% by weight based on the total weight of the lubricating composition.

13. The lubricating composition according to claim 11, wherein the at least one base oil is present in an amount of 0 to 30% by weight based on the total weight of the lubricating composition.

14. The lubricating composition according to claim 11, which comprises at least one further additive selected from the group consisting of an antiwear additive, EP additive, corrosion inhibitor and/or rust inhibiting additives, metal deactivator, detergent, dispersant, friction modifier, pour point depressant, antioxidant, anti-ageing composition, odorant, dye, antifoam additive, demulsifier, viscosity index improver and mixtures thereof

15. A process of preparation of components AA as defined in claim 9, wherein at least one compound A of the general formula (I) is reacted with at least one compound B of the general formula (III) and with other compounds of the general formula (II) under hydrosilylation conditions and in the presence of a hydrosilylation catalyst.

16. The method according to claim 9, wherein RI is independently of one another methyl or phenyl.

17. The method according to claim 9, wherein c+f is equal to 2.
